(19) United States
(12) Patent Application Publication
(10) Pub. No.: US 2019/0323301 A1
(43) Pub. Date: Oct. 24, 2019

(54) RISER SUPPORT SYSTEM

(71) Applicant: MHWIRTH AS, KRISTIANSAND S (NO)

(72) Inventor: LARS POEHNER, HORTEN (NO)

(73) Assignee: MHWIRTH AS, KRISTIANSAND S (NO)

(21) Appl. No.: 16/466,036

(22) PCT Filed: Dec. 13, 2017
(86) PCT No.: PCT/NO2017/050322

§ 371 Date: Jun. 3, 2019

(30) Foreign Application Priority Data
Dec. 16, 2016 (NO) 20162003

(51) Int. Cl. E21B 19/00; E21B 17/01; B63B 35/44; B66D 1/52

(52) U.S. Cl. CPC E21B 19/004; B66D 1/52; B63B 35/4413; E21B 17/01

(57) ABSTRACT

A wireline tensioner includes at least one sheave, a first accumulator unit, a second accumulator unit, a hydraulic distribution system, and a hydraulic cylinder unit which is operatively connected to the at least one sheave, to the first accumulator unit and to the second accumulator unit via the hydraulic distribution system. The first accumulator unit receives hydraulic fluid from the hydraulic distribution system at a first hydraulic pressure. The second accumulator unit receives the hydraulic fluid from the hydraulic distribution system at a second hydraulic pressure. The first hydraulic pressure is lower than the second hydraulic pressure.

The present invention relates to a riser support system, such as a system suitable for supporting a riser suspended from a floating vessel or connecting the floating vessel to the sea floor.

### BACKGROUND

As subsea oil and gas fields at great water depths are being developed, the facilities used in drilling and production of hydrocarbons will increasingly be floating structures such as drilling ships, semi-submersible platforms and drilling rigs, etc. These vessels move under the influence of waves, winds and currents and risers or pipes suspended by the vessel or linking the vessel with the subsea wells are also influenced by, for example, sea currents. Such risers are commonly supported by a riser tensioner system, for example as described in WO 2012/016765.

In many operating areas, severe weather conditions often develop rapidly, leaving only little time to secure or pull the riser. This includes sea currents, which can change within very short time windows. For example, a rig may experience a current of e.g. 5 knots in one direction, which goes to zero and turns within a short period of time. This may require an adjustment of the riser suspension system to adapt it to the new flow conditions, in order to avoid damage or excessive loads on the riser and associated equipment.

There is a thus a need for systems and techniques to be able to handle such varying operating conditions in a better manner compared to known solutions. The present invention has the objective to provide methods and systems with advantages compared to such conventional solutions.

### SUMMARY

In an embodiment, there is provided a wireline tensioner having at least one sheave and a hydraulic cylinder unit operatively connected to the at least one sheave, the hydraulic cylinder unit fluidly connected to a first accumulator unit and to a second accumulator unit via a hydraulic distribution system, wherein the first accumulator unit is configured to receive hydraulic fluid from the hydraulic distribution system at a first hydraulic pressure, and the second accumulator unit is configured to receive hydraulic fluid from the hydraulic distribution system at a second hydraulic pressure, and wherein the first hydraulic pressure is lower than the second hydraulic pressure.

In an embodiment, there is provided a riser arrangement comprising a substantially vertically arranged riser, and a first riser tensioner arrangement comprising at least one first tensioner element connected to the riser and arranged to exert a first force on the riser such that a first force component of the first force acts in a transverse direction of the riser and a second force component of the first force acts in a longitudinal direction of the riser, and wherein the second force component is smaller than the first force component or substantially zero, wherein the at least one second tensioner element is a wireline, and the riser arrangement further comprises a wireline tensioner connected to the wireline.

In an embodiment, there is provided a method of controlling the motion of a riser suspended from a floating vessel, comprising the steps: providing a riser arrangement and operating the wireline tensioner to exert a transverse tensioning force on the riser.

The appended dependent claims and the detailed description below disclose further embodiments.

### BRIEF DESCRIPTION OF THE DRAWINGS

Examples of embodiments will now be described with reference to the appended drawings, in which:

FIGS. 1-2 illustrate a wireline tensioner according to an embodiment.

FIG. 3 illustrates a floating vessel according to one embodiment.

FIGS. 4-8 illustrate a riser arrangement according to embodiments.

FIGS. 9-13 illustrate examples of operating states of embodiments.

FIGS. 14A, 14B, 15A, 15B, 16 and 17 illustrate other embodiments of a wireline tensioner.

### DETAILED DESCRIPTION

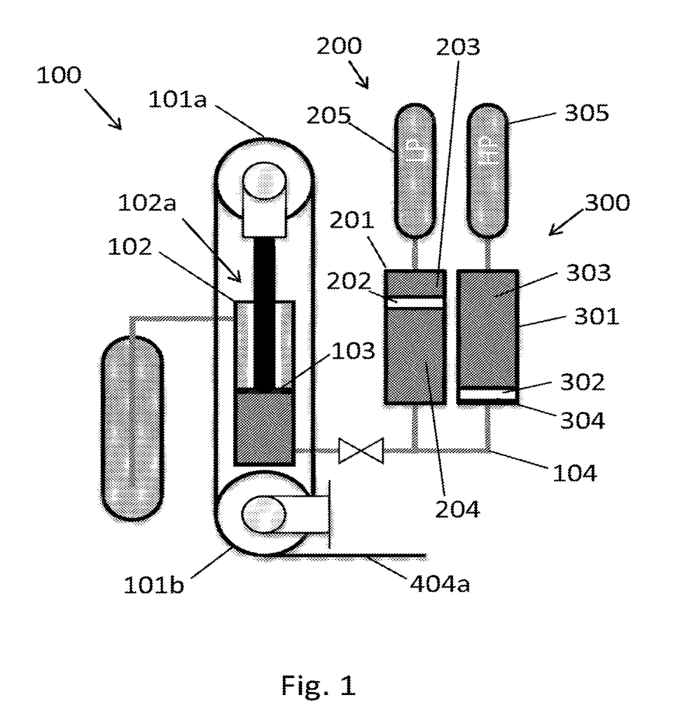

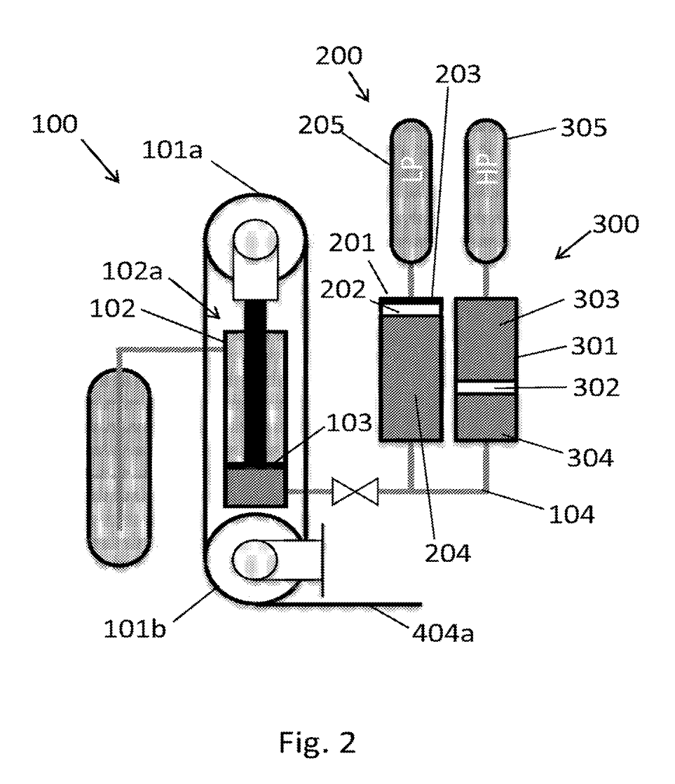

FIGS. 1 and 2 show an embodiment of a wireline tensioner 100. The wireline tensioner 100 has at least one sheave 101a,b and a hydraulic cylinder unit 102a operatively connected to the at least one sheave 101a,b. The hydraulic cylinder unit 102a comprises a tensioner piston 103 operatively arranged in a hydraulic cylinder 102 in the usual manner. The hydraulic cylinder unit 102a is fluidly connected to a first accumulator unit 200 and to a second accumulator unit 300 via a hydraulic distribution system 104. The first and second accumulator units 200, 300 each have a variable gas volume 203, 205, 303, 305. The variable gas volume 203, 205 of the first accumulator unit 200 comprises a first gas having a first pressure and the variable gas volume 303, 305 of the second accumulator unit 300 comprises a second gas having a second pressure. The first pressure is lower than the second pressure.

The accumulator units may be of any type, such as bladder accumulators, piston-cylinder based accumulators, or any other suitable type. In the arrangement shown in FIGS. 1-2, the first accumulator unit 200 comprises a first accumulator cylinder 201 having a first accumulator piston 202 therein, where the first accumulator piston 202 separates the first accumulator cylinder 201 into a first hydraulic side 203 and a first pneumatic side 204. The first hydraulic side 203 is fluidly connected to the hydraulic tensioning cylinder 102 via the hydraulic distribution system 104. Similarly, the second accumulator unit 300 comprises a second accumulator cylinder 301 having a second accumulator piston 302 therein, where the second accumulator piston 302 separates the second accumulator cylinder 301 into a second hydraulic side 303 and a second pneumatic side 304. The second hydraulic side 303 is fluidly connected to the hydraulic tensioning cylinder 102 via the hydraulic distribution system 104. A first gas storage unit 205 is fluidly connected to the first pneumatic side 203, and a second gas storage unit 305 is fluidly connected to the second pneumatic side 303.

By providing two accumulators with different pressures, a stepped operating profile of the wireline tensioner may be achieved. Referring to FIG. 1, a force acts on the wireline 404a such as to compress the hydraulic cylinder unit 102a. The wireline tensioner 100 will maintain a tensioning force in the wireline 404a which is determined by the gas pressure in the gas volume 203 and 205. The gas storage unit 205 may be arranged with sufficient volume such that this gas pressure remains substantially constant or with only very low variation over the stroke length of the first accumulator piston 202. This allows a substantially constant tensioning force from the wireline tensioner 100 during this part of the stroke length of the tensioner piston 103. During this part of the stroke length of the second accumulator piston 302 remains in its end stroke position as shown in FIG. 1, due to the higher pressure in the second gas storage unit 305.

If the wireline tensioner 100 is sufficiently compressed by a high force from the wireline 404a such that the first accumulator piston 202 reaches its end stroke position, as shown in FIG. 2, the tensioning force from the wireline tensioner 100 is determined by the gas pressure in the gas volume 303 and 305 acting on the second accumulator piston 302. By arranging the second gas storage unit 305 with a higher pressure, an increase in tensioning force on the wireline 404a can be obtained.

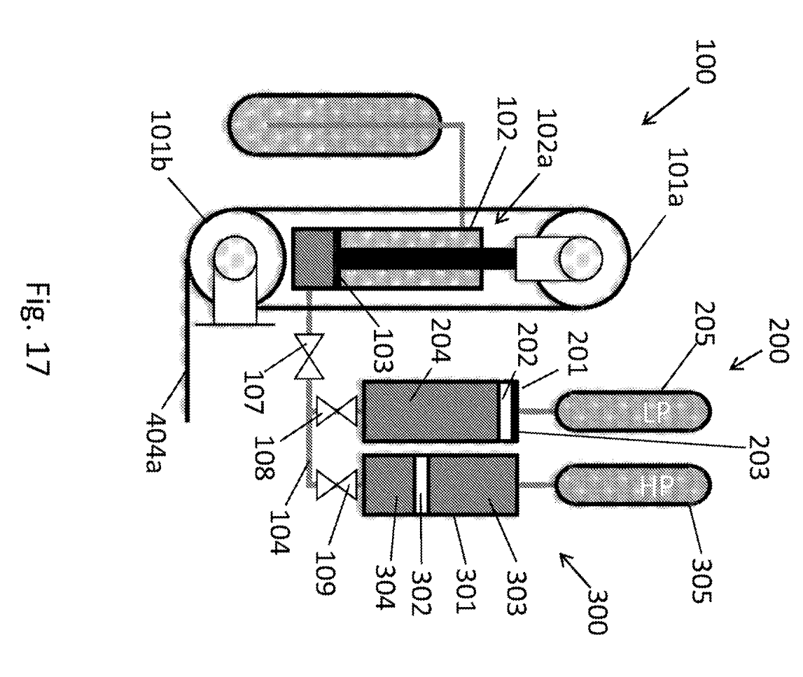

Alternatively, one or more controllable valves 107, 108, 109, as illustrated in FIG. 17, can be arranged in the hydraulic fluid line to control the point of transition between the first and the second accumulator units. Thereby it is not necessary to operate the first accumulator unit 200 to reach its end stroke position, while obtaining the same benefits of a stepped operating profile.

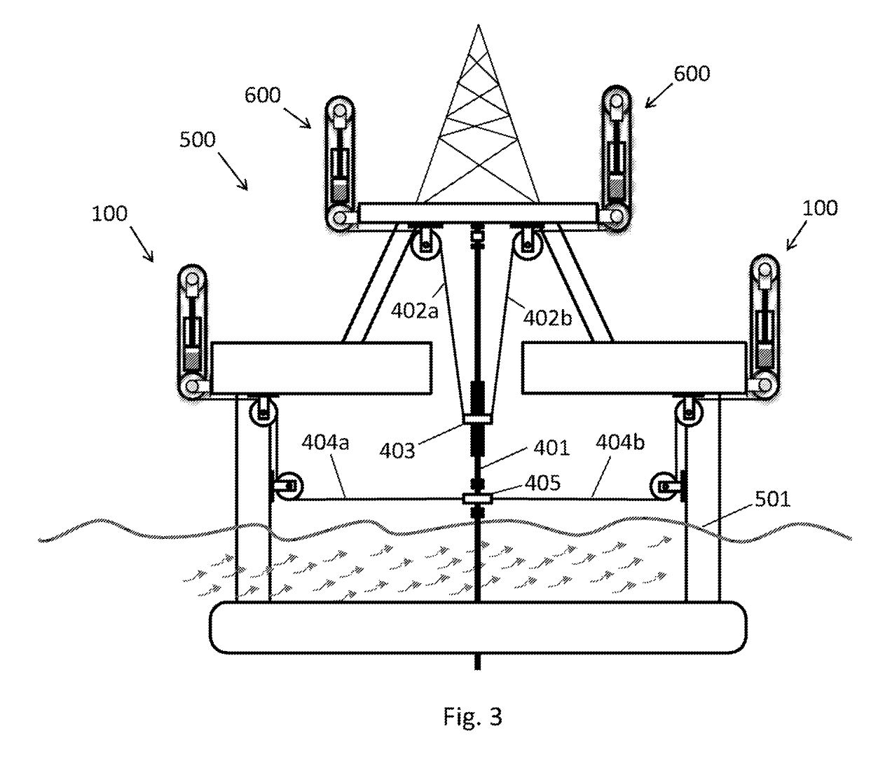

FIG. 3 shows an example of the wireline tensioner 100 in use, in this case to control the motion of a riser 401 suspended from a floating vessel 500. The riser 401 is suspended from the vessel 500, for example a drilling rig or a drillship, and longitudinal (vertical) tensioning is provided by conventional wireline tensioners 600 providing a substantially longitudinal tensioning force on the riser via wirelines 402a,b acting on tensioning ring 403. In this example, the wireline tensioner 100 is configured to exert a substantially transverse tensioning force on the riser 401 via wirelines 404a,b acting on tensioning ring 405, in the manner described in more detail below.

Optionally, wireline tensioners 100 according to the embodiment described in FIGS. 1-2 may be used instead of the wireline tensioners 600. The longitudinal tensioning may, alternatively, be provided by direct acting tensioners (DATs), or by alternative configurations.

In use, by providing a wireline tensioner 100 according to the embodiment described above, it is possible to adjust the pressure of the first gas storage unit 205 and/or the second gas storage unit 305 such as to adapt the operational characteristics of the tensioning system according to given requirements. These may, for example, vary according to the type of operation, the length of the riser 401, weather conditions, etc. By adjusting the gas pressure in the first gas storage unit 205 the tensioning force during the first part of the tensioner piston 103 stroke can be set, while adjusting the gas pressure in the second gas storage unit 305 controls the tensioning force during the second part of the tensioner piston 103 stroke. These levels can thus be set individually, and/or in a given relationship to each other to achieve the desired overall operating characteristics.

Operation of the wireline tensioner 100 may also comprise the step of adding or removing hydraulic fluid to or from the hydraulic distribution system 104. By adding or removing hydraulic fluid, an operator can adjust the point at which the first accumulator piston 202 reaches its end stroke (as shown in FIG. 2) and thus when the tensioning force is controlled by the gas pressure in the second gas storage unit 305. By adding hydraulic fluid, the first accumulator piston 202 will reach its end stroke earlier, thus a larger part of the tensioner piston 103 stroke will be controlled by the second accumulator unit 300. Similarly, removing hydraulic fluid will lead to a larger part of the tensioner piston 103 stroke being controlled by the first accumulator unit 200.

In one embodiment, the displacement volume of the tensioner piston 103 can be less than the sum of the displacement volumes of the first accumulator piston 202 and the second accumulator piston 302. This may further improve operational flexibility, for example allowing greater control by adding or removing hydraulic fluid.

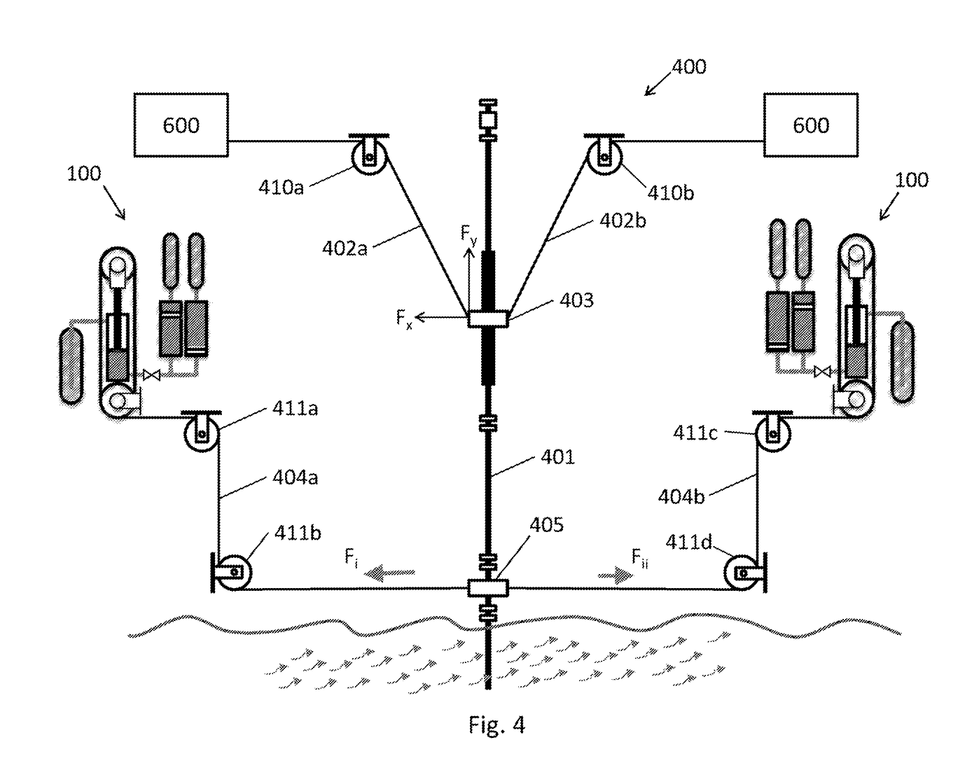

With reference to FIGS. 4-8, a riser arrangement 400 such as that illustrated in FIG. 3 will now be described in more detail. The riser arrangement 400 comprises a substantially vertically arranged riser 401. A riser tensioner system comprising riser tensioners 600 (shown only schematically here) is provided to maintain longitudinal (vertical) tension in the riser 401. The riser tensioners 600 are connected to the riser 401 via wirelines 402a,b which run via sheaves 410a,b and are connected to the tensioning ring 403. These tensioners are designed with the main purpose of providing a longitudinal (vertical) tensioning force, but the wirelines 402a,b may nevertheless have a certain angle in relation to the riser 401. With reference to FIG. 4, each wireline 402a,b may thus exert a force on the riser 401 which has a first force component Fₓ acting in a transverse direction of the riser 401 and a second force component F_{y} acting in a longitudinal direction of the riser 401, however the arrangement is designed such that the first force component Fₓ is smaller than the second force component F_{y} or the first force component Fₓ may be substantially zero.

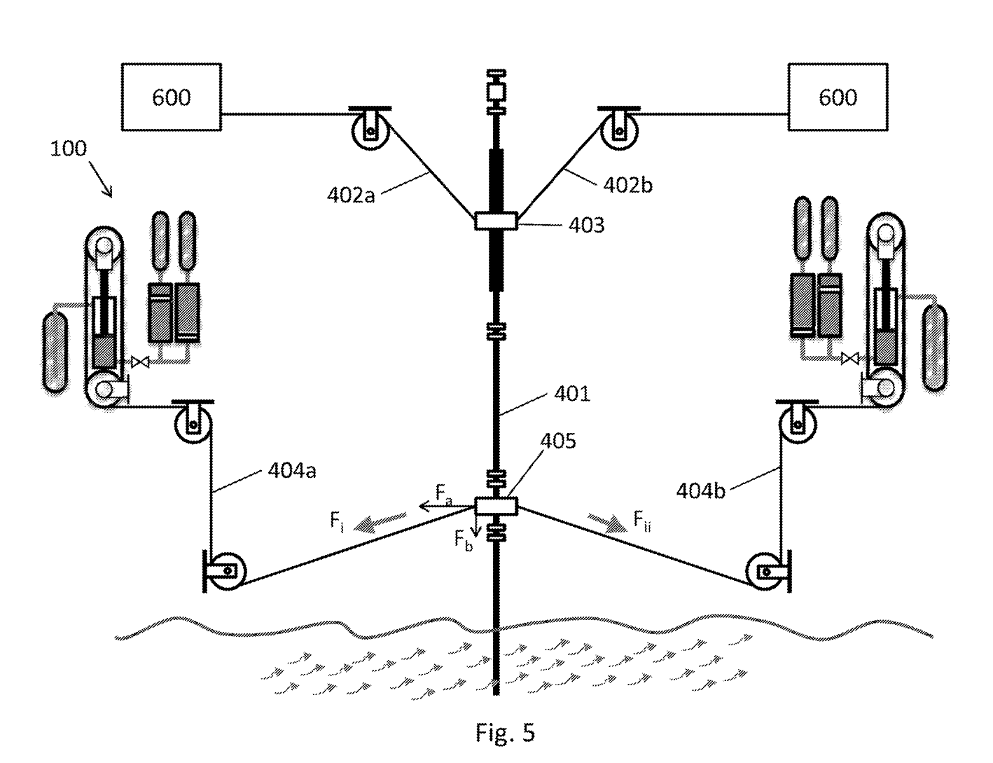

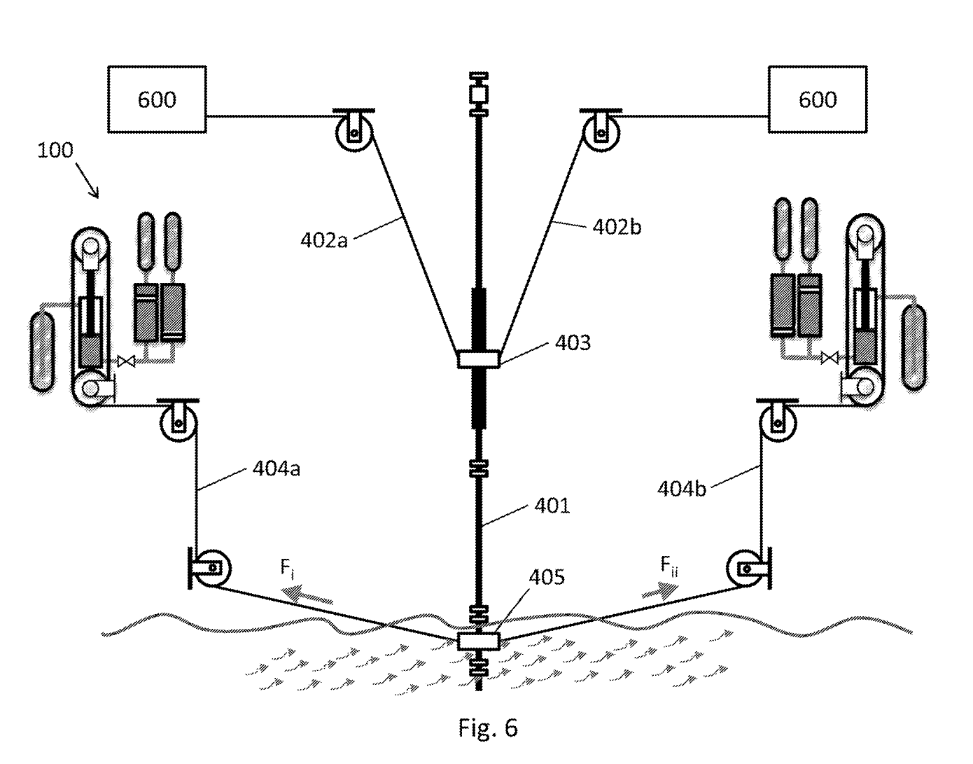

The riser arrangement 400 further comprises at least one lateral tensioner element 404a,b connected to the riser 401 and arranged to exert a lateral tensioning force Fᵢ, Fᵢᵢ on the riser 401. In the embodiment shown, the lateral tensioner elements 404a,b are wirelines extending from wireline tensioners 100 (as described above), via sheaves 411a-d, to tensioning ring 405. The wirelines 404a,b are arranged such as to provide a substantially, or predominantly, lateral tensioning force on the riser 401. Thus, the lateral tensioning force of the wirelines 404a,b will have a first force component Fₐ acting in a transverse direction of the riser 401 and a second force component F_{b} acting in a longitudinal direction of the riser 401, however the second force component F_{b} is smaller than the first force component Fₐ or the second force component F_{b} is substantially zero. FIG. 4 shows the latter case, in which the lateral tensioning forces act purely transversely on the riser 401. However, as a vessel 500 (see FIG. 3) is subject to heave, the wirelines 404a,b may not extend entirely transverse to the riser 401. This situation is illustrated in FIGS. 5 and 6. Nevertheless, arranging the sheaves 411a-d at appropriate positions will ensure that also when subjected to heave, the second force component F_{b} is smaller than the first force component Fₐ and the lateral tensioning system provides predominantly lateral tensioning and support for the riser 401.

The lateral tensioning ring 405 may be arranged at the same height on the riser 401 as the longitudinal tensioning ring 403, or the lateral tensioning ring 405 may be arranged lower on the riser 401 as the longitudinal tensioning ring 403. Arranging the tensioning ring 405 at the same height as tensioning ring 403 may simplify the structure, in that the rings may be connected or same ring structure can be utilized for both lateral and longitudinal tensioning. Arranging the tensioning ring 405 lower than the tensioning ring 403 may improve the performance of the lateral tensioning system, in that the lateral support forces will act on the riser 401 at a lower point.

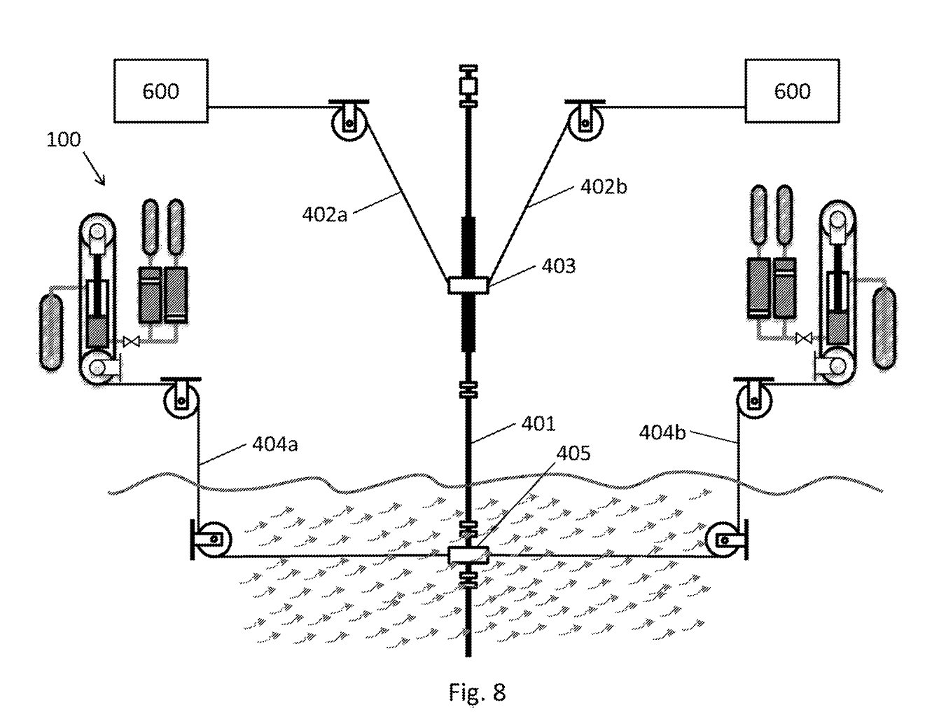

Illustrated in FIG. 8, the tensioning ring 405 may be arranged to be below a design waterline 501 (see FIG. 3) of the vessel 500. This may further improve performance, in that the lateral support forces will act on the riser 401 at a yet lower point.

FIGS. 4-6 illustrate the system in operation, when the vessel 500 is subjected to heave. The lateral tensioning forces Fᵢ and Fᵢᵢ acting on the riser 401 are illustrated. By means of the lateral tensioning system, the riser 401 is maintained in the substantially vertical orientation despite any sea currents. The length of the arrows indicate the magnitude of the forces Fᵢ, Fᵢᵢ acting on the wirelines 404a,b.

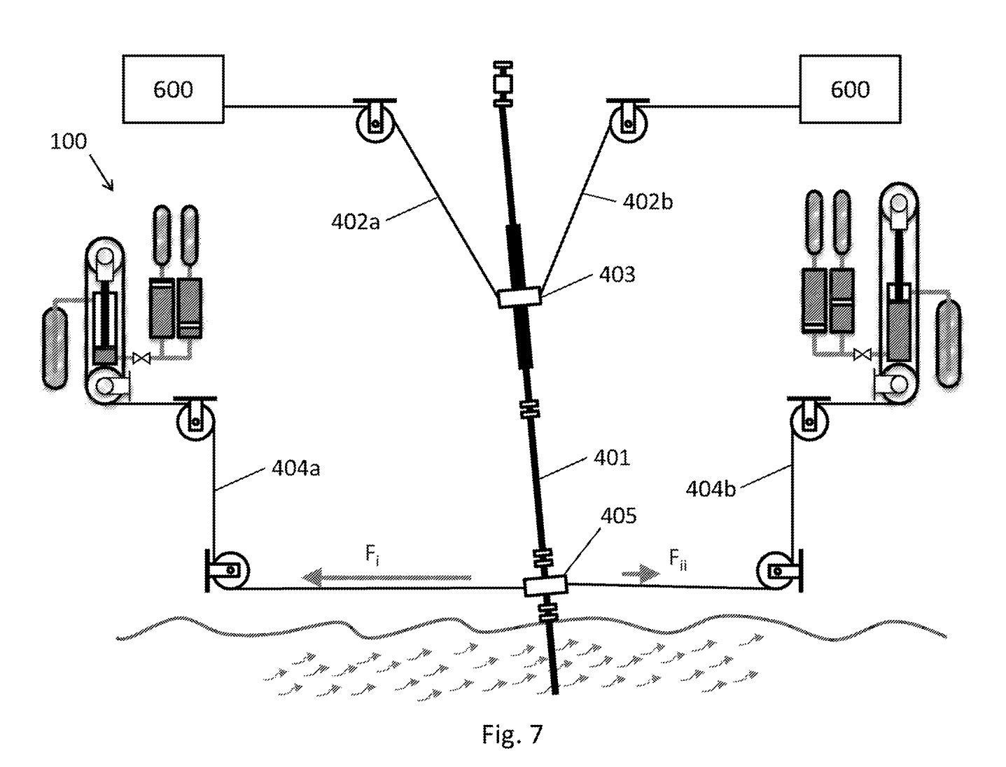

FIG. 7 illustrates a situation in which stronger sea currents are experienced. In this case the riser 401 is driven away from the vertical orientation, and the wireline 404a is extended, leading to the left hand side wireline tensioner 100 contracting further than in those cases shown in FIGS. 4-6. In this case, the second accumulator unit 300 will be activated, producing a significantly higher lateral tensioning force Fᵢ in the wireline 404a. (As indicated by the arrow symbolizing the magnitude of tensioning force Fᵢ.) In such a case, excessive deviation angles of the riser 401 can be avoided, reducing the risk of excessive loads on equipment or structural damage (for example if the riser 401 is driven sufficiently far so as to make mechanical contact with the vessel 500 structure). A riser arrangement 400 according to this embodiment is therefore better able to cope with, for example, strong or rapidly changing sea currents.

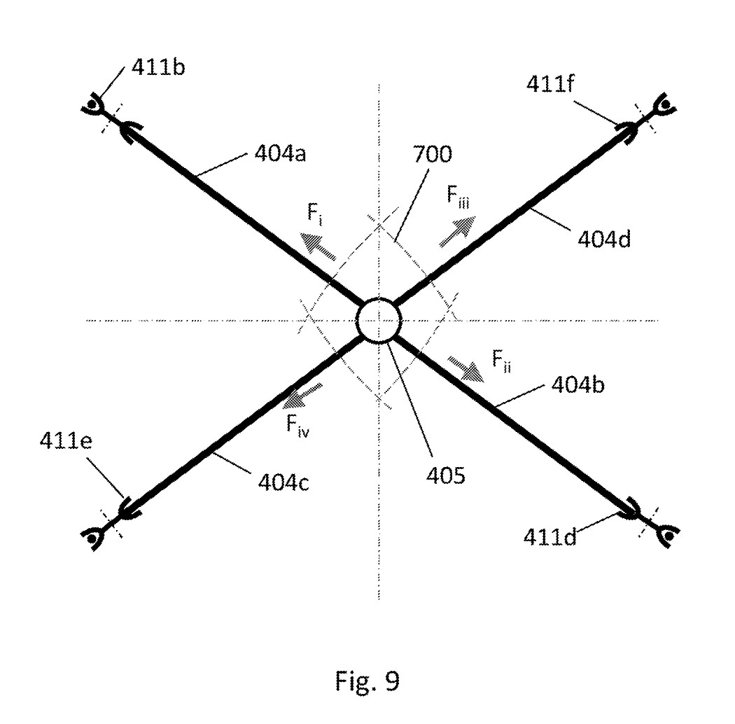

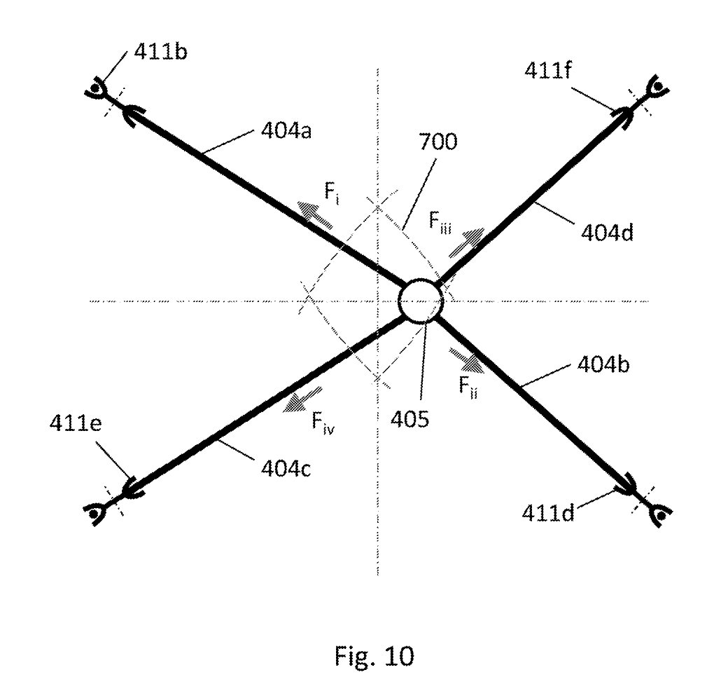

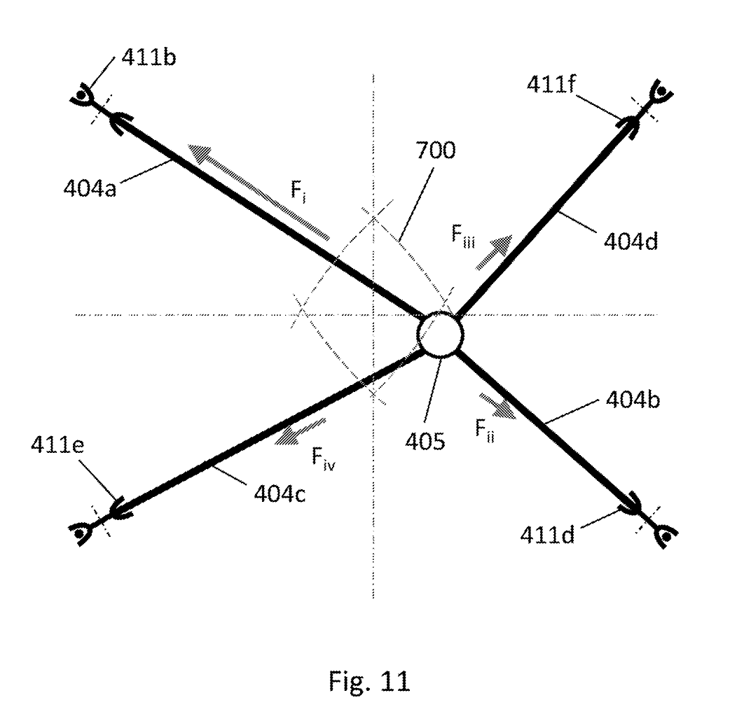

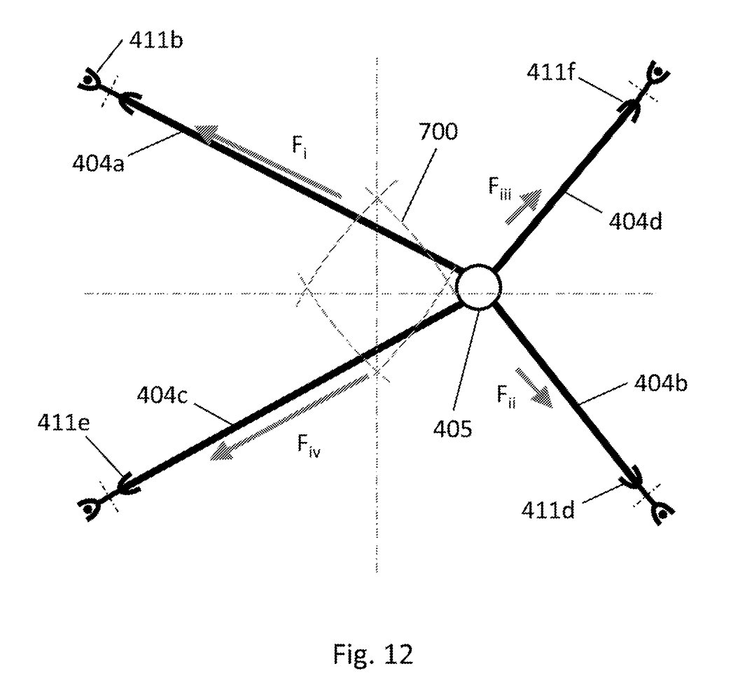

Two or more lateral tensioner elements may be employed, with associated components. FIGS. 9-12 illustrate a top view of a system having four lateral tensioner elements 404a-d. Four lateral tensioning forces Fᵢ₋ᵢᵥ act on the tensioning ring 405. The magnitude of the lateral tensioning forces Fᵢ₋ᵢᵥ are indicated for different positions of the riser 401/tensioning ring 405. As the riser 401 is driven farther off the nominal, vertical position, the different lateral tensioning forces Fᵢ₋ᵢᵥ increase. It is thus, by means of system design and operational configuration through adjusting the gas pressures in the first and second gas storage units 205, 305, and/or by adjusting the amount of hydraulic fluid in the hydraulic distribution system 104, possible to define an operational envelope 700 for the system. Inside the operational envelope 700, a first lateral tensioning force is acting on the riser 401 to maintain the nominal, vertical orientation. If the riser 401 is, for example, subject to large currents and driven outside the operational envelope 700, a larger lateral tensioning force acts in the required direction (see FIGS. 11 and 12) in order to avoid any further displacement and move the riser 401 back towards the vertical orientation.

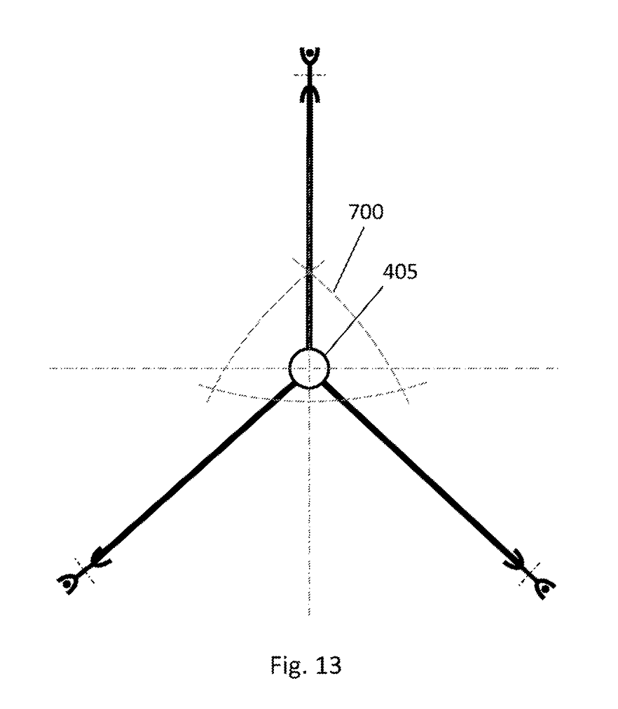

Any appropriate number of lateral tensioner elements may be used, depending on the overall system design and the operational requirements. FIG. 13 illustrates an example with three lateral tensioner elements, and the corresponding operational envelope 701.

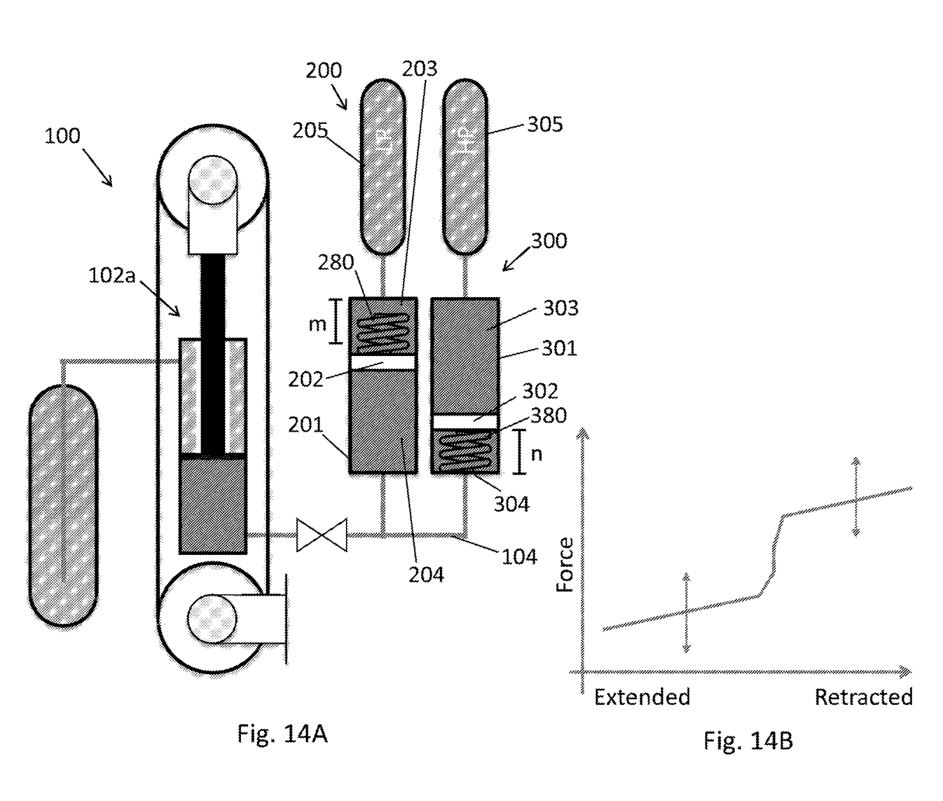

In an embodiment, illustrated in FIG. 14A, the wireline tensioner 100 may have an elastic element arranged in least one of the first accumulator cylinder 201 and the second accumulator cylinder 301. The elastic element is arranged to exert a force between the accumulator cylinder 201,301 and the respective accumulator piston 202, 302 over an end part m, n of a stroke length of the respective piston 202, 302. In FIG. 14A, the elastic elements are springs 280 and 380 which are mounted on the pistons 202 and 302. The springs may alternatively be mounted on the cylinder 201 or 301. As the piston 202 or 302 approaches the end stroke position, the spring 280 or 380 will exert a linearly increasing force between the piston 202 or 302 and the respective cylinder 201 or 301. This provides a smoother transition between the low pressure and the high pressure accumulators, which is illustrated in FIG. 14B, showing the force acting on the wireline from the tensioner 100 as a function of its position between a fully extended state to a fully retracted state. The arrows indicate that the force can be adjusted according to, for example, varying operating requirements, by varying the gas pressure in the gas storage units 205 and 305.

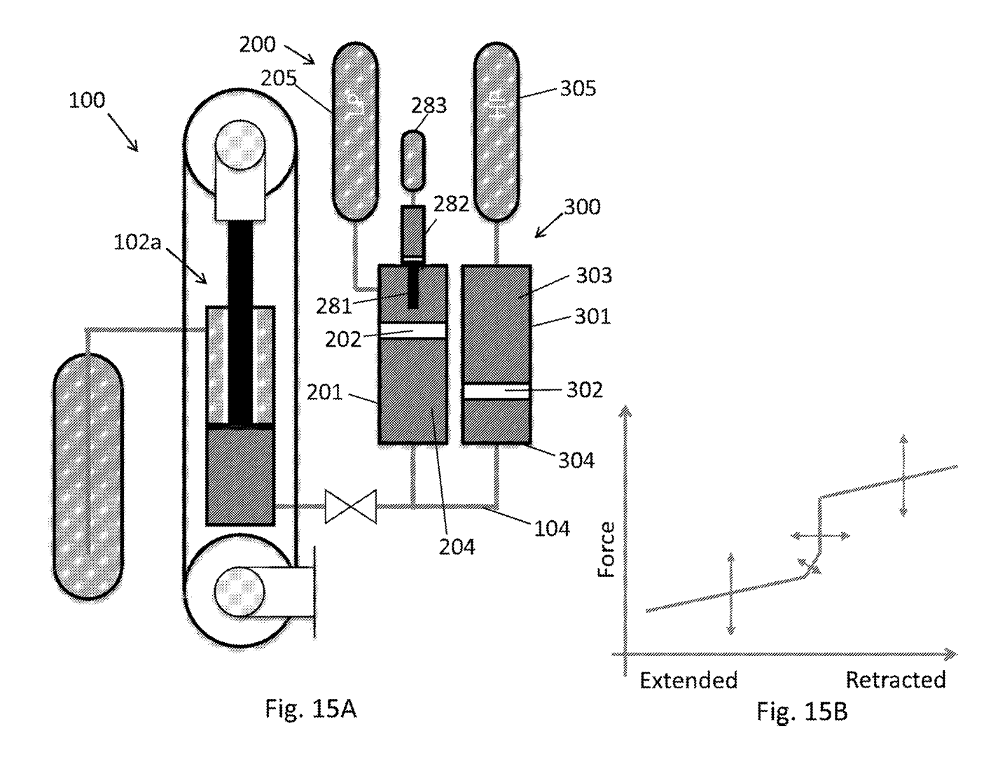

FIG. 15A illustrates an alternative arrangement, in which the elastic element is a cylinder unit having a rod 281 extending into the accumulator cylinder 201 and arranged to engage the piston 202 over an end part of its stroke. The rod 281 is connected to a gas-filled cylinder 282, in which gas is compressed as the rod 281 moves into the cylinder 282. A gas storage 283 may be provided in conjunction with the cylinder 282. As opposed to the passive springs described above, this setup allows the elastic element force to be varied by adjusting the gas pressure in the gas storage 283. This permits both a smoother transition between the low pressure and high pressure accumulators, but also the ability to vary the force profile during the transition, as indicated in FIG. 15B.

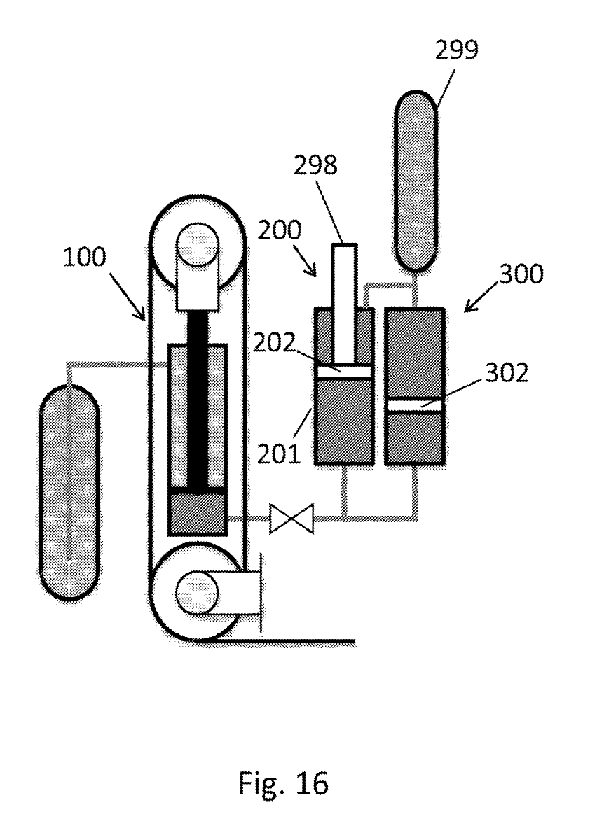

FIG. 16 illustrates another embodiment, in which the first accumulator unit 200 has a rod 298 arranged with the first accumulator piston 202 and extending out of the first accumulator cylinder 201. A gas storage 299 is provided and fluidly connected to both accumulator units 200 and 300. By means of the reduced piston surface area of the first accumulator piston 202 because of the rod 298, the same gas pressure can be supplied to both accumulator units. The difference between the surface areas of the pistons 202 and 302 on the gas side will determine the difference in hydraulic accumulator pressure supplied. In this embodiment, a single gas storage unit can be used, thereby simplifying the overall arrangement.

The invention is not limited to the embodiments described herein; reference should be had to the appended claims.

1-18. (canceled)

19. A wireline tensioner comprising:
at least one sheave;
a first accumulator unit;
a second accumulator unit;
a hydraulic distribution system; and
a hydraulic cylinder unit which is operatively connected to the at least one sheave, to the first accumulator unit and to the second accumulator unit via the hydraulic distribution system,
wherein,
the first accumulator unit is configured to receive hydraulic fluid from the hydraulic distribution system at a first hydraulic pressure,
the second accumulator unit is configured to receive the hydraulic fluid from the hydraulic distribution system at a second hydraulic pressure, and
the first hydraulic pressure is lower than the second hydraulic pressure.

20. The wireline tensioner as recited in claim 19, wherein,
the first accumulator unit comprises a first accumulator cylinder which comprises a first accumulator piston arranged therein, the first accumulator piston being configured to separate the first accumulator cylinder into a first hydraulic side and a first pneumatic side, the first hydraulic side being fluidly connected to a hydraulic tensioning cylinder via the hydraulic distribution system, and
the second accumulator unit comprises a second accumulator cylinder which comprises a second accumulator piston arranged therein, the second accumulator piston being configured to separate the second accumulator cylinder into a second hydraulic side and a second pneumatic side, the second hydraulic side being fluidly connected to the hydraulic tensioning cylinder via the hydraulic distribution system.

21. The wireline tensioner as recited in claim 20, wherein,
the first pneumatic side comprises a first gas having a first pressure,
the second pneumatic side comprises a second gas having a second pressure, and
the first pressure is lower than the second pressure or the first pressure is equal to the second pressure.

22. The wireline tensioner as recited in 21, wherein,
the first pneumatic side and the second pneumatic side are fluidly connected, and
the wireline tensioner further comprises a gas storage unit which is fluidly connected to the first pneumatic side and to the second pneumatic side.

23. The wireline tensioner as recited in claim 20, further comprising:
a first gas storage unit which is fluidly connected to the first pneumatic side; and
a second gas storage unit which is fluidly connected to the second pneumatic side.

24. The wireline tensioner as recited in claim 20, wherein,
the hydraulic cylinder unit comprises a tensioner piston which is operatively arranged in the hydraulic tensioning cylinder, and
a displacement volume of the tensioner piston is less than a sum of a displacement volume of the first accumulator piston and a displacement volume of the second accumulator piston.

25. The wireline tensioner as recited in claim 20, wherein at least one of,
the first accumulator cylinder further comprises an elastic element arranged therein, the elastic element being configured to exert a force between the first accumulator cylinder and the first accumulator piston over an end part of a stroke length of the first accumulator piston, and
the second accumulator cylinder further comprises an elastic element arranged therein, the elastic element being configured to exert a force between the second accumulator cylinder and the second accumulator piston over an end part of a stroke length of the second accumulator piston.

26. The wireline tensioner as recited in claim 25, wherein,
the elastic element is a spring, or
the elastic element is a gas-filled cylinder unit.

27. The wireline tensioner as recited in claim 19, wherein the hydraulic distribution system further comprises at least one of:
a first valve operable to control a fluid connection between the first accumulator unit and the hydraulic cylinder unit;
a second valve operable to control a fluid connection between the second accumulator unit and the hydraulic cylinder unit; and
a third valve operable to control a fluid connection between the hydraulic cylinder unit and the first accumulator unit and the second accumulator unit.

28. A riser arrangement comprising:
a riser which is arranged to be substantially vertical;
a first riser tensioner arrangement comprising,
at least one first tensioner element connected to the riser and arranged to exert a first force on the riser so that a first force component of the first force acts in a transverse direction of the riser and a second force component of the first force acts in a longitudinal direction of the riser, the second force component either being smaller than the first force component or being substantially zero, and
at least one second tensioner element; and
the wireline tensioner as recited in claim 19, the wireline tensioner being connected to the wireline.

29. The riser arrangement as recited in claim 28, wherein the at least one second tensioner element is provided as a wireline.

30. The riser arrangement as recited in claim 28, wherein the second riser tensioner arrangement comprises at least one second tensioner element connected to the riser, the at least one second tensioner element being arranged to exert a second force on the riser so that a first force component of the second force acts in a transverse direction of the riser and a second force component of the second force acts in a longitudinal direction of the riser, the first force component either being smaller than the second force component or being substantially zero.

31. The riser arrangement as recited in claim 30, wherein,
the at least one first tensioner element is connected to the riser via a first connecting element,
the at least one second tensioner element is connected to the riser via a second connecting element, and
the second connecting element is arranged vertically at a same height on the riser as the first connecting element or is arranged vertically lower on the riser than the first connecting element.

32. The riser arrangement as recited in claim 31, wherein the riser is suspended from a floating vessel.

33. The riser arrangement as recited in claim 32, wherein the second connecting element is located below a waterline of the floating vessel.

34. A method of controlling a motion of a riser suspended from a floating vessel, the method comprising:
providing the riser arrangement as recited in claim 28; and
operating the wireline tensioner to exert a transverse tensioning force on the riser.

35. The method as recited in claim 34, further comprising at least one of:
adjusting a pressure of the first gas, and
adjusting a pressure of the second gas.

36. The method as recited in claim 34, further comprising:
adding or removing the hydraulic fluid to or from the hydraulic distribution system.
